(19) United States
(12) Patent Application Publication
(10) Pub. No.: US 2026/0221457 A1
(43) Pub. Date: Jul. 30, 2026

(54) SEMI-CONDENSED ELECTRODE FOR A LITHIUM-ION BATTERY

(71) Applicant: Schaeffler Technologies AG & Co. KG, Herzogenaurach (DE)

(72) Inventors: Kewei Liu, Wadsworth, OH (US); Raziyeh Ghahremani, Wooster, OH (US); Chan-Yeop Yu, Wooster, OH (US); Rashid Farahati, Copley, OH (US)

(21) Appl. No.: 19/040,640

(22) Filed: Jan. 29, 2025

(51) Int. Cl. H01M 4/62; H01M 4/02; H01M 4/04; H01M 4/38

(52) U.S. Cl. CPC H01M 4/625; H01M 4/0411; H01M 4/0419; H01M 4/0485; H01M 4/622; H01M 2004/021; H01M 4/382

(57) ABSTRACT

A semi-condensed electrode may include a semi-condensed cathode formed from a liquid electrolyte, an active material including lithium, carbon nanotubes, and a polymer binder. A semi-condensed electrode may include a separator. A semi-condensed electrode may further include an anode separated from the semi-condensed cathode by a separator material.

### TECHNICAL FIELD

The present disclosure relates generally to a battery electrode, and more particularly, to a battery electrode with a semi-condensed cathode providing high energy density.

### BACKGROUND

The mass loading of an electrode is a key parameter associated with the energy density of a battery such as, but not limited to, a lithium-ion battery. Attempts to improve loading by increasing a thickness of solid-state cathode materials suffer from mechanical degradation, stress, relatively high heat generation, and a limited rate capability (e.g., limited charge/discharge rate capabilities). There is therefore a need to develop systems and methods addressing the above deficiencies.

### SUMMARY

In embodiments, the techniques described herein relate to a battery cell including an anode; a cathode, where at least one of the anode or the cathode is formed as a semi-condensed electrode formed from a liquid electrolyte, an active material, and a polymer binder; and a separator between the anode and the cathode.

In embodiments, the techniques described herein relate to a battery cell, where the semi-condensed electrode further includes carbon nanotubes.

In embodiments, the techniques described herein relate to a battery cell, where a weight percentage of the carbon nanotubes in the semi-condensed electrode is in a range of 1 to 10 weight percent.

In embodiments, the techniques described herein relate to a battery cell, where a thickness of the semi-condensed electrode is equal to or greater than 200 micrometers.

In embodiments, the techniques described herein relate to a battery cell, where a loading capacity of the semi-condensed electrode is equal to or greater than 50 mg/cm2.

In embodiments, the techniques described herein relate to a battery cell, where the active material includes lithium.

In embodiments, the techniques described herein relate to a battery cell, where a weight percentage of the polymer binder in the semi-condensed electrode is in a range of 0.5 to 30 weight percent.

In embodiments, the techniques described herein relate to a cell stack including a layered structure formed from one or more cells, where a particular one of the one or more cells includes an anode; a cathode, where at least one of the anode or the cathode is formed as a semi-condensed electrode formed from a liquid electrolyte, an active material, and a polymer binder; and a separator between the anode and the cathode.

In embodiments, the techniques described herein relate to a cell stack, where the semi-condensed electrode further includes carbon nanotubes.

In embodiments, the techniques described herein relate to a cell stack, where a weight percentage of the carbon nanotubes in the semi-condensed electrode is in a range of 1 to 10 weight percent.

In embodiments, the techniques described herein relate to a cell stack, where a thickness of the semi-condensed electrode is equal to or greater than 200 micrometers.

In embodiments, the techniques described herein relate to a cell stack, where a loading capacity of the semi-condensed electrode is equal to or greater than 50 mg/cm2.

In embodiments, the techniques described herein relate to a cell stack, where a weight percentage of the polymer binder in the semi-condensed electrode is in a range of 0.5 to 30 weight percent.

In embodiments, the techniques described herein relate to a cell stack, further including a first conductor connected to the anode and a second conductor connected to the cathode.

In embodiments, the techniques described herein relate to a method for fabricating a battery cell including forming an anode slurry including a first liquid electrolyte, a first active material, and a first polymer binder; forming a cathode slurry including a second liquid electrolyte, a second active material, and a second polymer binder; depositing the anode slurry between a first conductor and a separator to form a semi-condensed anode; and depositing the cathode slurry between the separator and a second conductor to form a semi-condensed cathode.

In embodiments, the techniques described herein relate to a method, where at least one of depositing the anode slurry or depositing the cathode slurry is performed by at least one of casting, spray coating, or extrusion.

In embodiments, the techniques described herein relate to a method, where a thickness of at least one of the semi-condensed anode or the semi-condensed cathode is equal to or greater than 200 micrometers.

In embodiments, the techniques described herein relate to a method, where a loading capacity of the semi-condensed cathode is equal to or greater than 50 mg/cm2.

In embodiments, the techniques described herein relate to a method, where at least one of the anode slurry or the cathode slurry further include carbon nanotubes.

In embodiments, the techniques described herein relate to a method, where a weight percentage of the carbon nanotubes is in a range of 1 to 10 weight percent.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a simplified perspective view of a cell of an electrode suitable for use in a battery, in accordance with one or more embodiments of the present disclosure.

FIG. 1B illustrates a simplified perspective view of a multi-layered electrode, in accordance with one or more embodiments of the present disclosure.

FIG. 2 illustrates a bar chart depicting the thickness and loading capacity of various cathode material types, in accordance with one or more embodiments of the present disclosure.

FIG. 3 illustrates a plot of conductivity of a semi-condensed cathode as a function of a weight percentage of carbon nanotubes present, in accordance with one or more embodiments of the present disclosure.

FIG. 4 illustrates a plot of voltage as a function of areal capacity for an LMO half cell with a semi-condensed cathode, in accordance with one or more embodiments of the present disclosure.

FIG. 5 illustrates an electrochemical impedance spectroscopy (EIS) plot of an LMO half cell with a semi-condensed cathode, in accordance with one or more embodiments of the present disclosure.

FIG. 6 is a flow diagram illustrating steps performed in a method 600 for fabricating a semi-condensed electrode, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing a semi-condensed electrode providing high loading capacity in a lithium-ion battery. In some embodiments, an electrode includes a semi-condensed anode and/or cathode formed from a slurry including active material, liquid electrolyte, and a polymer binder. In some cases, a semi-condensed electrode may further include carbon nanotubes (CNTs). This semi-condensed cathode may remain in a semi-solid state and is not dried during a fabrication process. It is contemplated herein that such a configuration may enable substantially higher mass loading and corresponding energy densities than existing geometries including solid-state geometries. In particular, it is contemplated that the systems and methods disclosed herein may enable loading capacities equal to or greater than 50 mg/cm² while maintaining exceptional mechanical properties, thermal properties, and rate capacities. It is further contemplated that the systems and methods disclosed herein may enable cathode thicknesses equal to or greater than 200 micrometers, which may contribute to high energy density and low processing cost.

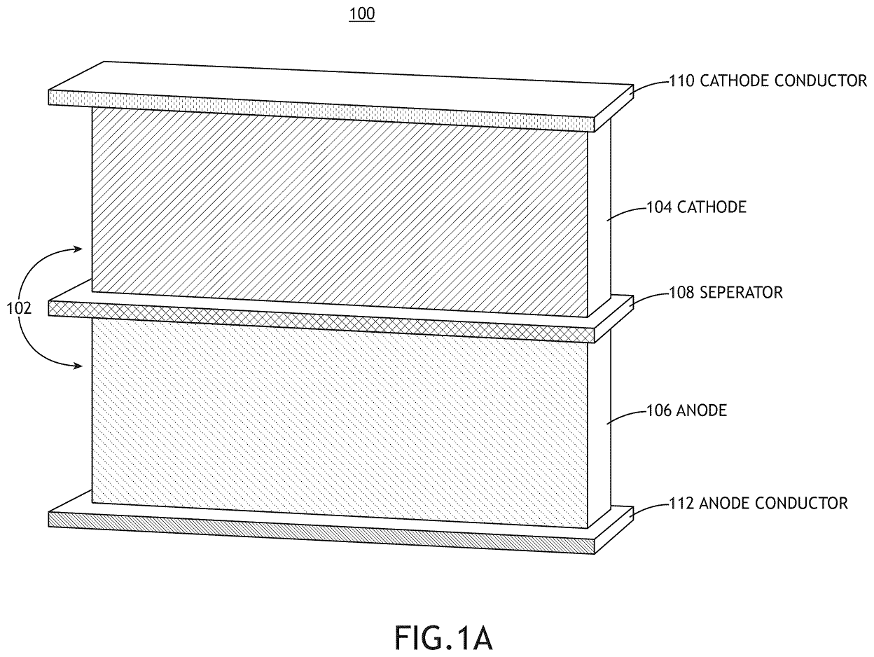

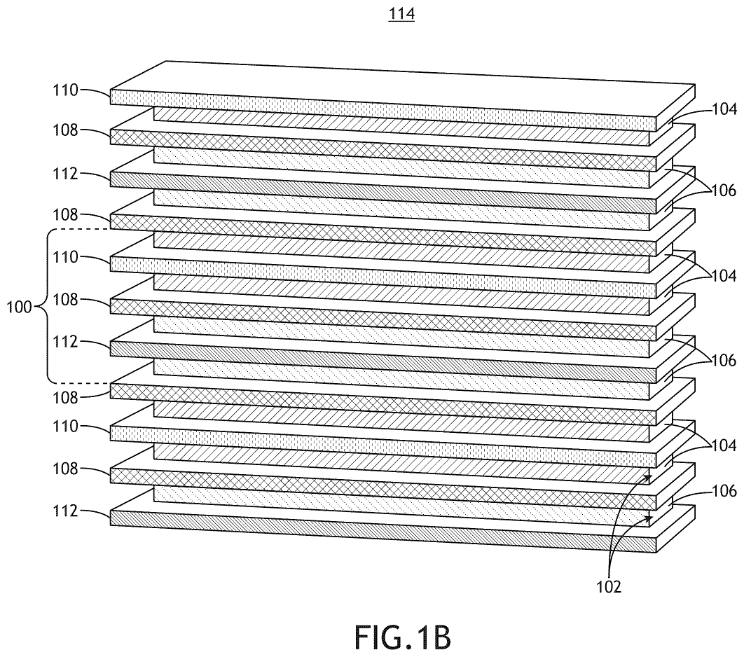

Referring now to FIGS. 1A-6, systems and methods providing a semi-condensed electrode for a lithium-ion battery is described in greater detail, in accordance with one or more embodiments of the present disclosure.

FIG. 1A illustrates a simplified perspective view of a cell 100 suitable for use in a battery, in accordance with one or more embodiments of the present disclosure. In particular, FIG. 1A illustrates a layered structure in which electrodes 102 (e.g., a cathode 104 and an anode 106) are separated by a separator 108. Further, the cell 100 may include a cathode conductor 110 connected to the cathode 104 as well as an anode conductor 112 connected to the anode 106. In embodiments, a cell 100 includes at least one semi-condensed electrode 102 (e.g., a semi-condensed cathode 104 and/or anode 106).

It is recognized that such a design may support a wide range of battery chemistries and designs. In some embodiments, the cell 100 is a lithium-ion cell, where one or more active lithium compounds are in the cathode 104 and/or the anode 106.

In some embodiments, a battery includes multiple stacked cells 100. FIG. 1B illustrates a simplified perspective view of a multi-layered cell stack 114, in accordance with one or more embodiments of the present disclosure. In FIG. 1B, the cell stack 114 includes alternating layers of electrodes 102 (e.g., cathodes 104 and/or anodes 106, where at least some are semi-condensed) and inactive materials (e.g., the cathode conductors 110, the anode conductors 112, and the separators 108). Further, FIG. 1B depicts a configuration in which the cathode conductors 110 and the anode conductors 112 are located between layers of material forming the cathodes 104 and anodes 106, respectively.

In some embodiments, one or more material layers forming a semi-condensed electrode 102 (e.g., a semi-condensed cathode 104 and/or an anode 106) is formed as a semi-condensed layer formed from a combination of active material for energy storage, a liquid electrolyte promoting current flow, carbon nanotubes to promote conductivity, and one or more polymer binders to provide a desired semi-condensed state. Such a semi-condensed cathode 104 may be characterized as a semi-solid material or a gel.

The active material may include any material suitable for providing energy storage. In some embodiments, the active material includes lithium such that a resulting electrode 102 may be referred to as a lithium-ion electrode 102. For example, a semi-condensed electrode 102 may be formed as a lithium-ion manganese oxide (LMO) electrode 102, where the active material (e.g., in a cathode 104) may include manganese oxide in any suitable form including, but not limited to Li₂Mn₂O₄, LiMnO₂, Li₂MnO₂, or a composite thereof. As another example, a semi-condensed electrode 102 may be formed as a lithium iron phosphate (LFP) electrode 102, where the active material (e.g., in a cathode 104) may include LiFePO₄. As another example, a semi-condensed electrode 102 may be formed as a lithium nickel manganese cobalt oxide (Li-NMC) electrode 102, where the active material (e.g., in a cathode 104) may include a mixed-metal oxide of lithium, nickel, manganese, and cobalt. As another example, the active material in a semi-condensed electrode 102 (e.g., in an anode 106) may include silicon, a carbon compound (e.g., graphene, graphite, or the like), and/or a metal alloy (e.g., aluminum, tin, magnesium, silver, or the like).

The liquid electrolyte may include any liquid promoting current flow such as, but not limited to, a lithium salt within a solvent (e.g., an organic solvent). For example, the liquid electrolyte may include, but is not limited to, lithium hexafluorophosphate (LiPF6), dimethyl carbonate (DMC), diethyl carbonate (DEC), propylene carbonate (PC), ethylene carbonate (EC), ethyl methyl carbonate (EMC), lithium bis(oxalato)borate (LiBOB), Lithium difluoro(oxalato)borate (LiDFOB), or Lithium Bis(fluorosulfonyl)imide (LiFSI) or variants (e.g., LiTFSI, or the like).

The polymer binder may include any polymer suitable for providing desired mechanical properties, absorption of the liquid electrolyte and/or active material, and lithium transport properties. For example, the polymer binder may include any electrochemically-stable cross-linked polymer. Nonlimiting examples include poly(vinylidene difluoride) (PVDF) or associated copolymers (e.g., PVDF-HFP, or the like) or styrene-butadiene rubber (SBR). The cathode 104 and/or anode 106 may include any weight percentage of polymer binder. In some embodiments, the cathode 104 includes polymer binder with a weight percentage in a range of 0.5 to 30 weight percent.

In some embodiments, a semi-condensed electrode 102 includes carbon nanotubes (CNTs) or other carbon compounds, which may increase a conductivity. A semi-condensed electrode 102 may include any concentration of carbon nanotubes. As an illustration, a semi-condensed electrode 102 may include carbon nanotubes with a weight percent of 0.1% to 10%. The concentration of carbon nanotubes in a semi-condensed electrode 102 may be determined by balancing any number of factors such as, but not limited to, the loading capacity and the conductivity. For example, increasing the concentration of carbon nanotubes may improve conductivity but may reduce the loading capacity since the carbon nanotubes do not contribute to charge storage. Accordingly, the concentration of carbon nanotubes may be selected to be a minimum concentration required to provide conductivity above a selected threshold. Further, in some embodiments, a semi-condensed electrode 102 includes a dispersant to promote dispersion or percolation of the carbon nanotubes throughout the cathode 104. Any dispersant may be used including, but not limited to, a polymer solvent or a polymeric amide solvent. Non-limiting examples of dispersants include polyethylene oxide (PEO), polyamide, or polyether.

A separator 108 may include any materials known in the art suitable for providing a barrier between a cathode 104 and an anode 106 while allowing flow of lithium ions. For example, the separator 108 may include, but is not limited to, polyolefin.

The cathode conductors 110 and/or the anode conductors 112 may include any conductor suitable for providing electrical contact with the cathode 104 such as, but not limited to, aluminum foil.

It is contemplated herein that a semi-condensed electrode 102 as disclosed herein may provide numerous advantages over solid-state materials.

For example, a semi-condensed electrode 102 (e.g., a cathode 104 and/or an anode 106) as disclosed herein may enable a relatively high ratio of active materials to inactive materials, which may result in relatively high loading capacity, high energy density, and relatively low processing cost. Referring to FIGS. 1A-1B as an illustration, a semi-condensed electrode 102 as disclosed herein may be fabricated with increased thickness (T) compared to solid-state materials while maintaining desirable mechanical, thermal, and electrical properties. In a general sense, increasing the thickness of materials forming cathodes 104 (and commensurate increases in the thickness of materials forming anodes 106) may result in a higher ratio of active materials (e.g., within the cathodes 104 and/or anodes 106) relative to inactive materials (e.g., materials forming the cathode conductors 110, the anode conductors 112, or the separators 108). In particular, such a thickness increase may require fewer cells 100 in an electrode 102 to produce a desired loading capacity and thus require fewer inactive layers associated with the various cells 100.

However, it is contemplated herein that simply increasing the thickness of a cathode and/or anode material in a typical solid-state configuration may result in various negative impacts that ultimately limit the achievable thickness. For example, simply increasing the thickness of a solid-state material may result in undesirable mechanical degradation and stress, which may manifest as delamination of the cathode material from an associated conductor. As another example, increasing the thickness of a solid-state material may further result in undesirable heat generation and/or reduced lithium-ion transfer rates, which may negatively impact durability and/or rate capacity.

However, a semi-condensed electrode 102 as disclosed herein may provide a 3D electrical and ionic conductive network that may provide excellent electrical and thermal performance while also being robust to stress changes and mechanical degradation.

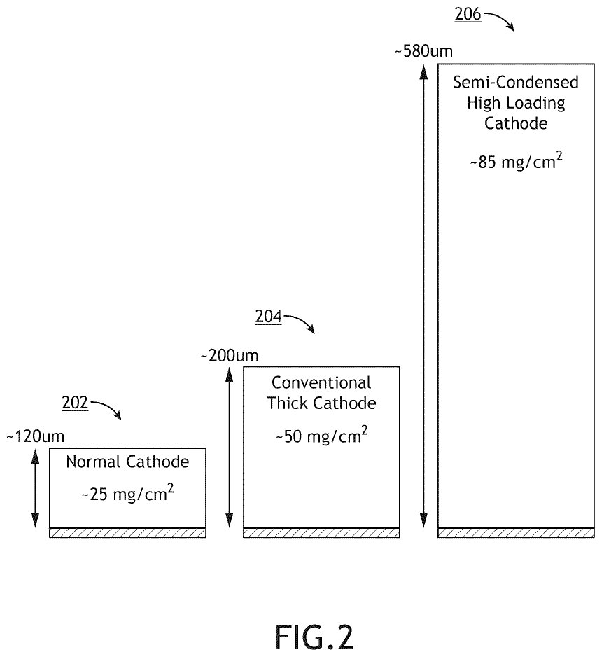

### Referring Now to FIGS. 2-5, the Performance of Semi-condensed Electrodes 102 Is described in greater detail.

FIG. 2 illustrates a bar chart depicting the thickness and loading capacity of various cathode material types, in accordance with one or more embodiments of the present disclosure. The first bar two bars represent typical solid-state cathode material systems at various stages in development. The first bar 202 represents a typical commercially-viable solid-state cathode material, which may be limited to a typical thickness of approximately 120 μm and a loading capacity of approximately 25 mg/cm². The second bar 204 represents some efforts to develop a “thick cathode,” which may allow for increased loading capacity of approximately 50 mg/cm² and thicknesses up to approximately 200 μm. However, such efforts still typically suffer from mechanical and/or thermal issues. The third bar 206 represents a semi-condensed cathode 104 as disclosed herein, which may provide substantially increased thickness and loading capacity. For example, FIG. 2 depicts thickness values of approximately 580 μm and loading capacity values of approximately 85 mg/cm². However, it is to be understood that both the thickness value and the loading capacity of the semi-condensed cathode 104 in FIG. 2 are merely non-limiting examples and are not limiting. It is contemplated herein that a semi-condensed cathode 104 may exceed 580 μm and the loading capacity values of approximately 85 mg/cm². Further, although FIG. 2 depicts a semi-condensed cathode 104, a semi-condensed anode 106 may also be fabricated with a relatively higher thickness than a solid-state anode while maintaining desirable mechanical and/or thermal properties.

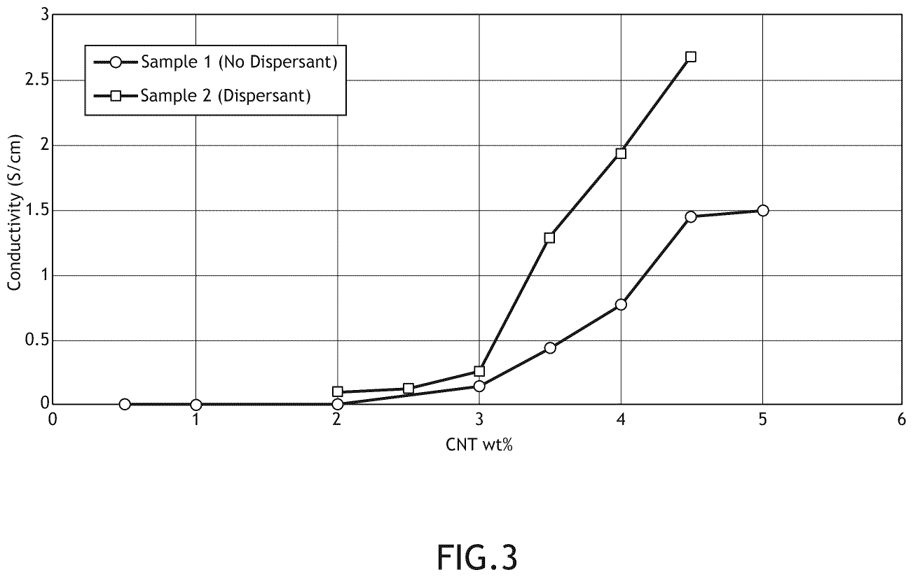

FIG. 3 illustrates a plot of conductivity of a semi-condensed electrode 102 as a function of a weight percentage of carbon nanotubes, in accordance with one or more embodiments of the present disclosure. In particular, the semi-condensed cathode 104 analyzed in FIG. 3 includes LMO, LiPF6, PMMA, CNTs, and optionally PEO as a dispersant. As shown in FIG. 3, the presence of carbon nanotubes promotes conductivity of the electrode 102. In the particular example considered in FIG. 3, the presence of carbon nanotubes provided a substantial increase in conductivity at percentages greater than or equal to 2 weight percent. Further, the use of a dispersant provided additional conductivity performance.

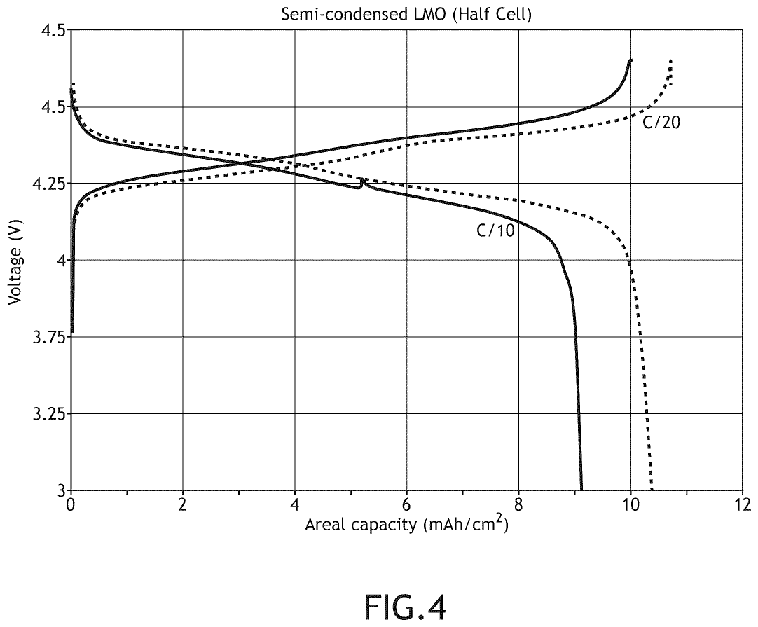

FIG. 4 illustrates a plot of voltage as a function of areal capacity for an LMO half cell with a semi-condensed electrode 102, in accordance with one or more embodiments of the present disclosure. In particular, FIG. 4 depicts data for C/10 and C/20 rates. As shown in FIG. 4, the use of a semi-condensed electrode 102 in this LMO half cell provided a specific capacity of up to 10.4 mAh/cm², which is substantially higher than existing technologies, which may provide a specific capacity on the order of 4-5 mAh/cm².

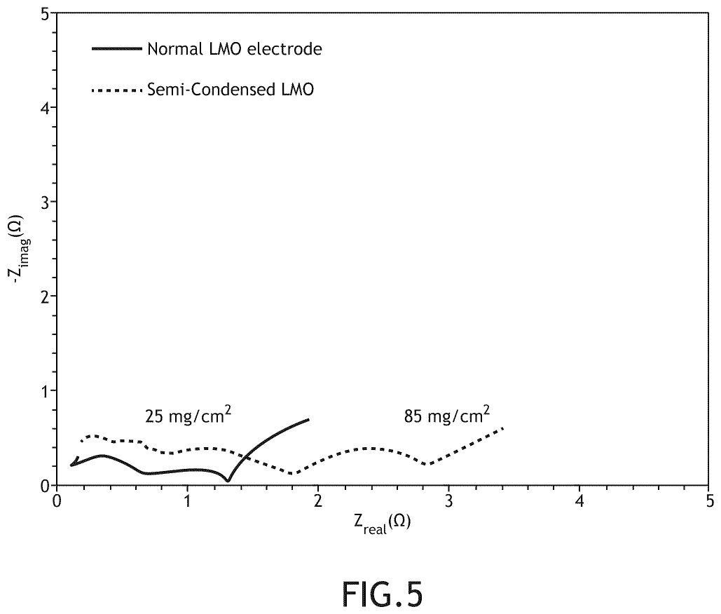

FIG. 5 illustrates an electrochemical impedance spectroscopy (EIS) plot of an LMO half cell with a semi-condensed electrode 102, in accordance with one or more embodiments of the present disclosure. In particular, FIG. 5 depicts EIS performance for both a traditional LMO electrode having a loading capacity of 25 mg/cm2 as well as a semi-condensed electrode 102 having a loading capacity of 85 mg/cm2 . Further, FIG. 5 is generated under conditions providing a 50% state of charge (SOC) level. As shown in FIG. 5, a semi-condensed electrode 102 may provide relatively high loading capacity with a relatively low impedance.

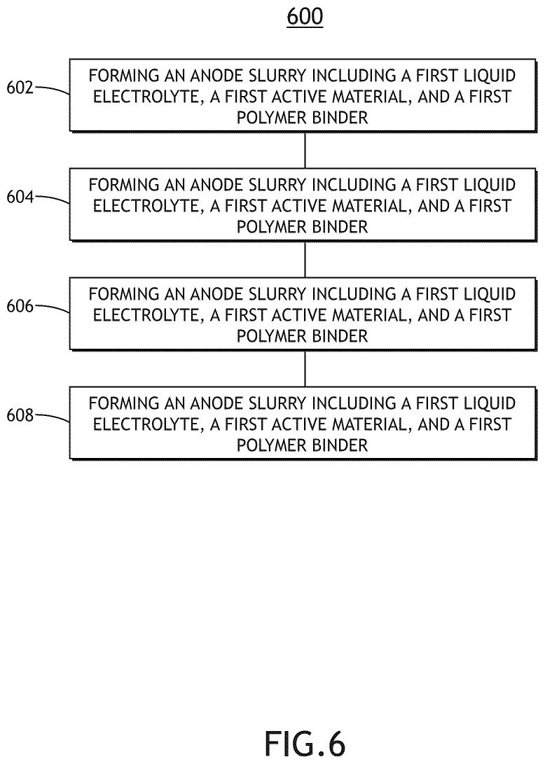

Referring now to FIG. 6, FIG. 6 is a flow diagram illustrating steps performed in a method 600 for fabricating a semi-condensed electrode, in accordance with one or more embodiments of the present disclosure. The embodiments and enabling technologies described previously herein in the context of the electrode 102 should be interpreted to extend to the method 600. However, the method 600 is not limited to the architecture of the electrode 102.

In some embodiments, the method 600 includes a step 602 of forming an anode slurry including a first liquid electrolyte, a first active material, and a first polymer binder. In some embodiments, the method 600 includes a step 604 of forming a cathode slurry including a second liquid electrolyte, a second active material, and a second polymer binder. In some embodiments, the method 600 includes a step 606 of depositing the anode slurry between a first conductor and a separator to form a semi-condensed anode. In some embodiments, the method 600 includes a step 608 of depositing the cathode slurry between the separator and a second conductor to form a semi-condensed cathode.

It is contemplated herein that neither the anode slurry deposited in step 606 or the cathode slurry deposited in step 608 need to be dried at any point. In this way, the semi-condensed anode and the semi-condensed cathode may remain in a semi-solid or gel state throughout the fabrication process, which may beneficially provide increased mechanical robustness relative to solid-state cathode technologies.

As described with respect to the electrode 102, the compositions and relative concentrations of the components in the anode slurry and/or the cathode slurry may be selected to provide a desired combination of loading capacity, conductivity, and internal resistance. In some embodiments, the anode slurry and/or the cathode slurry provides a loading capacity of at least 50 mg/cm². In some embodiments, the anode slurry and/or the cathode slurry provides a loading capacity of at least 85 mg/cm². In some embodiments, the anode slurry and/or the cathode slurry further include carbon nanotubes and further optionally include a dispersant. For example, the carbon nanotubes may be provided with a weight percent in a range of 0.1 to 10 percent.

Further, the step 602 and the step 604 may include mixing the constituent components in any order. In embodiments in which the anode slurry and/or the cathode slurry include carbon nanotubes, the carbon nanotubes may be mixed with the liquid electrolyte and/or the active material prior to mixing in the polymer binder. In this way, the liquid components may be well dispersed prior to interacting with the polymer binder.

The step 606 of depositing the anode slurry and/or the step 608 of depositing the cathode slurry may be performed using any technique known in the art including, but not limited to, casting, spray coating, or extrusion. Further, the anode slurry and/or the cathode slurry may be deposited with any thickness to form semi-condensed electrodes 102 of any thickness. For example, at least one of the semi-condensed anode or the semi-condensed cathode may have a thickness equal to or greater than 200 micrometers. As another example, at least one of the semi-condensed anode or the semi-condensed cathode may have a thickness equal to or greater than 580 micrometers.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for applications.

### List of Reference Numbers

100 cell
102 electrode
104 cathode
106 anode
108 separator
110 cathode conductor
112 anode conductor
114 cell stack
202 first bar
204 second bar
206 third bar
600 method
602 step
604 step
606 step
608 step

What is claimed:

1. A battery cell, comprising:
an anode;
a cathode, wherein at least one of the anode or the cathode is formed as a semi-condensed electrode formed from a liquid electrolyte, an active material, and a polymer binder; and
a separator between the anode and the cathode.

2. The battery cell of claim 1, wherein the semi-condensed electrode further comprises carbon nanotubes.

3. The battery cell of claim 2, wherein a weight percentage of the carbon nanotubes in the semi-condensed electrode is in a range of 0.1 to 10 weight percent.

4. The battery cell of claim 1, wherein a thickness of the semi-condensed electrode is equal to or greater than 200 micrometers.

5. The battery cell of claim 1, wherein a loading capacity of the semi-condensed electrode is equal to or greater than 50 mg/cm².

6. The battery cell of claim 1, wherein the active material includes lithium.

7. The battery cell of claim 1, wherein a weight percentage of the polymer binder in the semi-condensed electrode is in a range of 0.5 to 30 weight percent.

8. A device, comprising:
a layered structure formed from one or more cells, wherein a particular one of the one or more cells comprises:
an anode;
a cathode, wherein at least one of the anode or the cathode is formed as a semi-condensed electrode formed from a liquid electrolyte, an active material, and a polymer binder; and
a separator between the anode and the cathode.

9. The device of claim 8, wherein the semi-condensed electrode further comprises carbon nanotubes.

10. The device of claim 9, wherein a weight percentage of the carbon nanotubes in the semi-condensed electrode is in a range of 0.1 to 10 weight percent.

11. The device of claim 8, wherein a thickness of the semi-condensed electrode is equal to or greater than 200 micrometers.

12. The device of claim 8, wherein a loading capacity of the semi-condensed electrode is equal to or greater than 50 mg/cm².

13. The device of claim 8, wherein a weight percentage of the polymer binder in the semi-condensed electrode is in a range of 0.5 to 30 weight percent.

14. The device of claim 8, further comprising a first conductor connected to the anode and a second conductor connected to the cathode.

15. A method for fabricating a battery cell comprising:
forming an anode slurry including a first liquid electrolyte, a first active material, and a first polymer binder;
forming a cathode slurry including a second liquid electrolyte, a second active material, and a second polymer binder;
depositing the anode slurry between a first conductor and a separator to form a semi-condensed anode; and
depositing the cathode slurry between the separator and a second conductor to form a semi-condensed cathode.

16. The method of claim 15, wherein at least one of depositing the anode slurry or depositing the cathode slurry is performed by at least one of casting, spray coating, or extrusion.

17. The method of claim 15, wherein a thickness of at least one of the semi-condensed anode or the semi-condensed cathode is equal to or greater than 200 micrometers.

18. The method of claim 15, wherein a loading capacity of the semi-condensed cathode is equal to or greater than 50 mg/cm².

19. The method of claim 15, wherein at least one of the anode slurry or the cathode slurry further comprise carbon nanotubes.

20. The method of claim 19, wherein a weight percentage of the carbon nanotubes is in a range of 0.1 to 10 weight percent.
